(19) United States
(12) Patent Application Publication
(10) Pub. No.: US 2021/0241261 A1
(43) Pub. Date: Aug. 5, 2021

(54) Method and System to Reduce Transaction Fee by Dynamic Mapping of Retail Cards and Main Credit Card

(71) Applicants: ARVIND KUMAR, (US); Bibhupriya Acharya, Toronto (CA)

(72) Inventors: Arvind Kumar, Irving, TX (US); Bibhupriya Acharya, Toronto (CA)

(21) Appl. No.: 16/856,623

(22) Filed: Apr. 23, 2020

Related U.S. Application Data
(60) Provisional application No. 62/967,979, filed on Jan. 30, 2020.

(51) Int. Cl. G06Q 20/34; G06Q 20/36; G06Q 20/32; G06Q 30/06; G06F 9/54

(52) U.S. Cl. CPC G06Q 20/3572; G06Q 20/367; G06F 9/547; G06Q 30/06; G06Q 20/322

(57) ABSTRACT

A method and system to reduce card transaction fee while enabling the payment from dynamically mapped retail cards. Being a mapping and API based solution, technical integration with any bank is much easier with very less cost while enabling the easy future enhancements. With this Solution customer will map all his retail card to any one credit card on app and while making the payments solutions will enable bank to take payment from the respective retail card for retailer. With this mapping-based solution customer will get same functionality, if due to any reason he is not able to use his mobile for payment and use the credit card mapped.

### BACKGROUND OF THE INVENTION

The field of the present invention relates to reduction of transaction fee for merchants when customers pay at its POS terminal. The present invention describes on mapping multiple retail cards to a any chosen credit card of a customer.

It may be known that an interchange fee or a transaction fee plays an important role for payments using payment cards. The transaction fee may be a major source of revenue for payment networks and banks. However, the transaction fee may be a burden to merchants.

Nowadays, cashless payments using cards/digital wallets for online-offline purchase are getting popular. The cards may include bank cards like debit/credit cards, virtual cards or the like. Moreover, the digital wallets support mobile-based or web-based application that may allow payment without physically using the cards. In some cases, the merchants may provide customers with retail store cards that can be used for purchasing from their store. The retail cards and debit cards may cost less to the merchants as there may be less or no transaction fee. In some scenarios, the customers may prefer using credit cards over the debit cards due to availability of more credit limit. In some other scenarios, the customers may not prefer applying for multiple retail cards as the retail cards cannot be used other than the corresponding stores. So, the customers may not have the tendency to apply for the multiple retail cards and may prefer having only specific retails cards of a store that the customers regularly purchase. Moreover, any new digital wallet or payment product requires new POS set-up, which maybe an additional cost to the merchants. The specific problems associated with the existing system that is described in the following.

### Problem 1

No benefit to merchants for interchange fee during a transaction: Generally, when a cardholder swipes a card on any merchant point-of-sale (POS) there may be a transaction fee associated with each transaction. The transaction fee may vary from 1% to 3% depending on the merchant. In last few years, few digital wallets came in market. However, these digital wallets may not provide any benefit to the merchant. Moreover, the merchant may need to upgrade the POS which might be additional cost to them. In some other scenarios, the merchants may provide retail cards to the customers that helps saving on the transaction fee. However, the customers may have very less tendency to carry multiple retail cards with them for purchasing.

### Problem 2

For any secure digital wallet banks must do good amount of IT changes.

In some cases, payment through digital wallets may not be fully secure. In order to provide a secure transaction using digital wallets, the digital wallet may be required to integrate with a bank. Such integration may require huge changes related to Information Technology (IT) system, which may be complex.

### Problem 3

If customer phone is unavailable, then payment through digital wallet is not possible. The present system of payment using digital wallets includes using of mobile-based or web-based applications. In some scenarios, it may happen that a customer loses his/her smartphone or battery of the smartphone may get drained. At such situations, the customer cannot make any payment using the digital wallet, until physical cards of the customer are available.

### DETAIL DESCRIPTIONS OF THE INVENTION

All illustrations of the drawings are for the purpose of describing selected versions of the present invention and are not intended to limit the scope of the present invention.

The field of the present invention relates to reduction of transaction fee, and more particularly to, method and system to reduce transaction fee by dynamic mapping of retail cards and regular credit card (let's call this main card)

The present invention discloses a system that includes two main components—an application and a mapping engine. The two-component design-based system enables a customer to map multiple retail cards with one regular credit card (main card) of a customer. When a customer maps the main card to multiple retail cards, a token and a unique device id for each customer is generated. The mapping engine helps an acquiring bank (acquiring bank and issuing bank are same for retail cards) in identification of mapping for any retail card. The main card thus can be used as the payment card on behalf of all other mapped retail cards.

Application and mapping engine interact with each other through APIs (Application Programming Interfaces).

### Solution for Problem 1

In the present invention, all the retail cards are mapped to one main card of a customer. When the customer swipes the main card or use mobile wallet, the mapping engine helps acquiring bank in identification of retail cards that is mapped to the main card. If any retail card is mapped, then payment is done from the mapped retail card and hence saving on transaction fee to merchant.

### Solution for Problem 2

The mapping engine uses same set of APIs to interact with all banks using different secure API key. The mapping engine can be integrated with any banks, with very less IT changes and banks just need to have a mechanism to store the mapping. It may be noted that the mapping engine will not store any of cardholder's information.

### Solution for Problem 3

If smartphone is not available, customer can use the main card, that is mapped with multiple retail cards. Moreover, as multiple retail cards are mapped to a main card, the customer may not require carrying all the retail cards physically. The payment will still be placed on the mapped retail card with the help of the mapping engine.

### BRIEF DESCRIPTION OF THE DRAWINGS

FIG. 1 is a diagram representing mapping of main card and retail cards;

FIG. 2 is a diagram representing a payment transaction based on mapping of a main card with multiple retail cards;

FIG. 3 is a diagram for mapping of main card and retail cards in the mentioned example.

FIG. 4 is a diagram for payments scenarios of main card and retail cards in mentioned example

### SOLUTION DESIGN AND DESCRIPTION

The two-component based design system of the present invention includes; mobile based or web-based application and mapping engine.

Mobile based or Web-based application: It is a mobile or web application that is accessible via smartphone or web, capable of interacting with a mapping engine with the help of secured APIs. Cardholder key information is not stored on this app.

Mapping Engine: This is an API-enabled component, capable of interacting with the mobile or web application and any bank with the help of the secured APIs. The engine can be integrated with any issuing bank of retail cards. The mapping engine has decision logic based on information passed by bank and the application. No cardholder information is stored on the Engine.

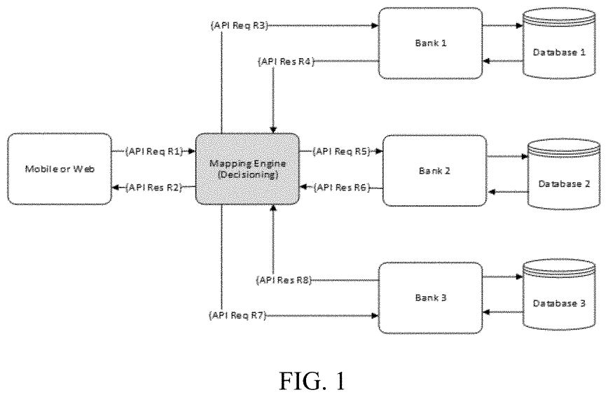

Mapping and Payment Process Flow: This is shown in FIG. 1.

Step 1: Initially, customer creates an account using the mobile/web application. During the account creation, details of a main card and retail cards are provided.

Step 2: The details of the main card and retail cards are sent to the mapping engine as API Req R1. The details are sent along with a device id or token.

Step 3: The mapping engine identifies issuing bank of the retail card. The information of the main card, retail cards and token or device id are then sent to the respective issuing bank using API Req R3, API Req R5, API Req R7.

Step 4: The banks 1, 2 and 3 stores the mapping information in their own backend. After storing the mapping information, a confirmation message is sent to the mapping engine through API Responses API Res R4, API Res R6 and API Res R8 respectively.

Step 5: The mapping engine then forwards the confirmation message back to application from the banks through response API Res R2. The card name selected by customer is stored in the application instead of card number.

It may be noted that rewards and payments functionality can be added in the system of the present invention as reward is already mapped to retail card number in any bank and once we enable this new mapping then the main card or device too is indirectly mapped to rewards.

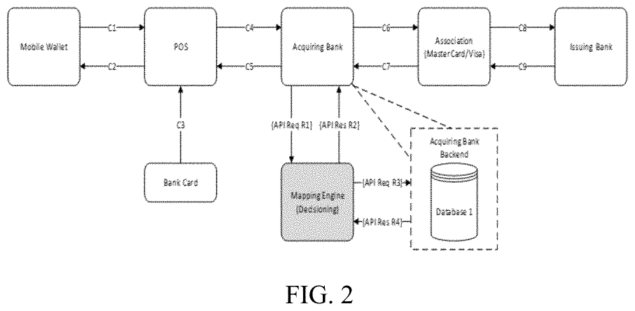

How Payment Works in this Solution Design: This is shown in FIG. 2

Step 1: When a customer uses a mobile wallet or swipes a bank card to make payment on POS, then transaction request goes to an Acquiring Bank.

Step 2: Acquiring bank passes on the information to the mapping engine as API Req R1 through secure APIs.

Step 3: Mapping Engine enquires the bank's database for mapping through API Req R3.

Step 4: The response from the database is received as API Res R4 by the mapping engine and it is passes back the decision as API Res R2 to make the payment on the mapped retail card if mapping exists or tells bank no mapping.

Step 5: If mapping does not exist, then transaction request will be passed through the payment networks to the issuing bank.

Step 6: The issuing bank authorizes it and completes the transaction from the main card as usual:

Flow when payment is made by Mobile wallet

### C1->C4->R1->R3->R4->R2->C5->C2

Flow when and payment is made by Main Card and Mapping exists

### C3->C4->R1->R3->R4->R2->C5

Flow when payment is made by Mobile wallet Mapping doesn't exists

### C1->C4->R1->R3->R4->R2->C6->C8->C9->C7->C5->C2

Flow when payment is made by Main Card and Mapping doesn't exists

### C3->C4->R1->R3->R4->R2->C6->C8->C9->C7->C5

### Example on Payment Scenarios

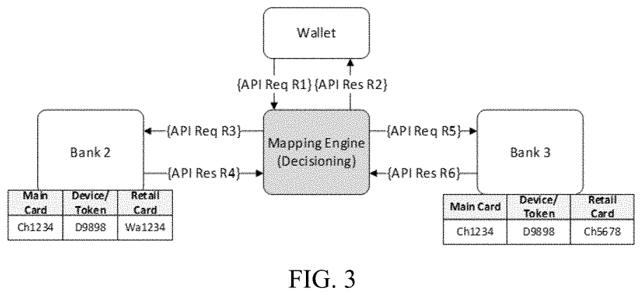

Registration: (FIG. 3)

Customer A has 3 cards:

1. Bank1 Mileage Plus card, with card number is Ch1234
2. Retailer1 retail card issued by Bank2, with card number is Wa1234
3. Retailer2 retail card issued by Bank3, with card number is Ch5678

Flow for Bank2: R1->R3->R4->R2

Flow for Bank 3: R1->R5->R6->R2

Retail card Wa1234 is mapped with main card Ch1234 in Bank2 backend and retail card Ch5678 is mapped with mapped with main card Ch1234 in Bank3 backend.

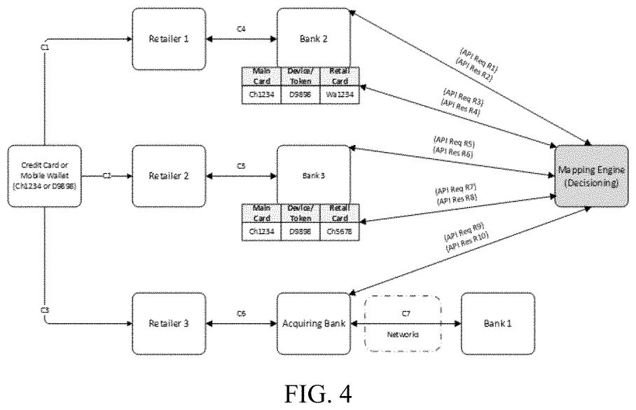

Payments scenarios: (FIG. 4)

During payment, when the Bank1 Mileage Plus card Ch1234 is swiped at retailer 1 or at retailer 2 the mapping engine checks for mapping of any retail card with the Bankl Mileage Plus card Ch1234, as shown in FIG. 4.

As mapping exists:

At Retailer payment will be done from Retail card Wa1234

At Retailer2 Payment will be done from Retail Card Ch5678

When the Bankl Mileage Plus card is swiped at retailer 3, as there is no mapping of retail card of that particular retailer 3 with the Bankl Mileage Plus card:

In Retailer3 Payment will be done from Bankl card Ch1234.

1. A method and system to save on traction fee to merchant: As this solution enables making the payments from respective retail card at retailer's POS hence will save merchant on the interchange fee.

2. A method and system to provide Unique feature of using digital wallet without smartphone:
Cardholder can map any number of retail cards on device, also he need not to worry if his smartphone is not functional at the time of payment. Once he uses the main card, the solution will enable merchant bank to identify the mapped retail card.

3. A method and system to make transactions Simple and Secure: Solution use a set of APIs and decisioning logic without storing cardholder information that makes the solution simple and secure.

4. A method and system to make Easy and economical integration with banks: Solution has the same set of APIs which can be used by any bank with different secured keys, hence it is easy to integrate with less IT cost.

5. A method and system to enable Easy enhancements to solution: Being a mapping-based mechanism, any further mapping can be pulled. Example Reward information already mapped to retail cards at bank side, enabled mapping of main card or device with retail card will indirectly enable the mapping of rewards too with them. Hence solution can be enhanced easily to apply reward with payments.
